(19) United States
(12) Patent Application Publication
(10) Pub. No.: US 2024/0267095 A1
(43) Pub. Date: Aug. 8, 2024

(54) MANAGEMENT APPARATUS, MANAGEMENT METHOD AND MANAGEMENT PROGRAM

(71) Applicant: Nippon Telegraph and Telephone Corporation, Tokyo (JP)

(72) Inventors: Riichi KUDO, Musashino-shi, Tokyo (JP); Tomoki Murakami, Musashino-shi, Tokyo (JP); Kahoko TAKAHASHI, Musashino-shi, Tokyo (JP); Tomoaki Ogawa, Musashino-shi, Tokyo (JP)

(21) Appl. No.: 18/562,712

(22) PCT Filed: May 20, 2021
(86) PCT No.: PCT/JP2021/019244

§ 371 Date: Nov. 20, 2023

(51) Int. Cl. H04B 7/0452; H04L 5/00; H04W 64/00

(52) U.S. Cl. CPC H04B 7/0452; H04L 5/0048; H04W 64/003

(57) ABSTRACT

Provided is a management device that performs wireless communication with a fixed terminal fixed in an environment, or performs wireless communication with the fixed terminal and a position estimation target, and manages a state of a wireless communication unit that performs wireless communication. The management device includes one or more wireless communication units that receive a wireless signal from a wireless communication unit, an input feature generation unit that converts channel information corresponding to the plurality of wireless communication units into a plurality of input features that can be input to a machine learning model, a position estimation model utilization unit that estimates and calculates a position of the position estimation target, and a model evaluation unit that outputs identification of whether or not an abnormality has occurred in any one of the wireless communication units.

### TECHNICAL FIELD

The present invention relates to a management device, a management method, and a management program.

### BACKGROUND ART

Internet of things (IOT) in which various devices are connected to the Internet is being implemented. Various devices such as an automobile, a drone, and a construction machine vehicle are becoming connected wirelessly. As wireless communication standards, supported wireless communication standards such as a wireless local area network (LAN) defined by the IEEE 802.11 standard, Bluetooth (registered trademark), cellular communication by LTE or 5G, low power wide area (LPWA) communication for IOT, electronic toll collection system (ETC) used for communication for vehicles, vehicle information and communication system (VICS), ARIB-STD-T109, and the like have also developed, and are expected to spread in the future.

In order to ensure high throughput and reliability performance, the wireless communication equipment adopts a multiple input multiple output (MIMO) communication technology using a plurality of antennas. The MIMO communication technology can enhance throughput and reliability performance by using channel information indicating how radio waves propagate between the transmission side and the reception side. For example, the wireless communication equipment on the transmission side supports a transmission function of a feedback signal that transmits channel information to the wireless communication equipment on the reception side (see Non Patent Literature 1).

In addition, a technique is known in which channel information regarding radio wave propagation is used to estimate a position of a wireless communication device (See Non Patent Literatures 2 and 3). For example, the position of the wireless communication device is identified based on arrival times, levels, and the like of wireless signals wirelessly communicated with a plurality of base stations.

### CITATION LIST

### Non Patent Literature

Non Patent Literature 1: “Part 11: Wireless LAN Medium Access Control (MAC) and Physical Layer (PHY) Specifications”, IEEE Computer Society, IEEE Std 802.11, 2016, p. 2396-p. 2400
Non Patent Literature 2: Y. Tao, and one other person, “A Novel System for WiFi Radio Map Automatic Adaptation and Indoor Positioning”, in IEEE Transactions on Vehicular Technology, vol. 67, no. 11, November 2018, p. 10683-p. 10692
Non Patent Literature 3: H. CAO, and five others, “Indoor Positioning Method Using WiFi RTT Based on LOS Identification and Range Calibration”, in Proc., ISPRS International Journal of Geo-Information, September 2020

### SUMMARY OF INVENTION

### Technical Problem

Conventionally, a position of a position estimation target located in the same environment as that of a fixed terminal can be estimated by using channel information of a wireless signal transmitted from a wireless communication unit of the fixed terminal. Further, the position of the position estimation target can be estimated by further using channel information of a wireless signal transmitted from the wireless communication unit of the position estimation target.

However, in a case where the position of the position estimation target is estimated using a plurality of pieces of channel information corresponding to a plurality of wireless communication terminals (a plurality of fixed terminals, or one or more fixed terminals and one or more position estimation targets), when an abnormality occurs in any one of the plurality of wireless communication terminals, there is an issue that the position estimation accuracy decreases and it is difficult to identify the cause of the abnormality.

The present invention has been made in view of the above circumstances, and an object of the present invention is to provide a technology capable of managing a state of an individual wireless communication terminal (a fixed terminal, or a position estimation target) that transmits a wireless signal or an individual wireless communication unit of an own device that receives the wireless signal in a position estimation device that estimates a position of a position estimation target using a plurality of pieces of channel information.

### Solution to Problem

A management device according to an aspect of the present invention that performs wireless communication with a fixed terminal fixed in an environment, or performs wireless communication with the fixed terminal and a position estimation target, and manages a state of a wireless communication unit that performs wireless communication, at least one of the number of wireless communication units of the fixed terminal or the position estimation target and the wireless communication units of an own device being plural, includes one or more wireless communication units that receive a wireless signal from a wireless communication unit performing wireless communication included in the fixed terminal or a wireless communication unit included in the fixed terminal and the position estimation target and acquire a plurality of pieces of channel information related to radio wave propagation from the wireless signal, an input feature generation unit that converts channel information corresponding to the plurality of wireless communication units into a plurality of input features that can be input to a machine learning model, a position estimation model utilization unit that estimates and calculates a position of the position estimation target by inputting the plurality of input features to a position estimation model obtained by modeling, by machine learning, a relationship between position information of the position estimation target and an input feature, and a model evaluation unit that outputs identification of whether or not an abnormality has occurred in any one of the wireless communication units of the fixed terminal or the position estimation target, and the own device, or an index for the identification by inputting each input feature of the input features of the plurality of wireless communication units to a generated individual management model for each of the fixed terminal or each of the position estimation target, for each wireless communication unit of the own device, or for a plurality of wireless communication units selected from the wireless communication units of the fixed terminal, the position estimation target, or the own device.

A management method according to an aspect of the present invention that performs wireless communication with a fixed terminal fixed in an environment, or performs wireless communication with the fixed terminal and a position estimation target, and manages a state of a wireless communication unit that performs wireless communication, at least one of the number of wireless communication units of the fixed terminal or the position estimation target and the wireless communication units of an own device being plural, includes steps of receiving, in the management device, by one or more wireless communication units, a wireless signal from a wireless communication unit performing wireless communication included in the fixed terminal or a wireless communication unit included in the fixed terminal and the position estimation target and acquiring a plurality of pieces of channel information related to radio wave propagation from the wireless signal, converting, by an input feature generation unit, channel information corresponding to the plurality of wireless communication units into a plurality of input features that can be input to a machine learning model, estimating and calculating, by a position estimation model utilization unit, a position of the position estimation target by inputting the plurality of input features to a position estimation model obtained by modeling, by machine learning, a relationship between position information of the position estimation target and an input feature, and outputting, by a model evaluation unit, identification of whether or not an abnormality has occurred in any one of the wireless communication units of the fixed terminal or the position estimation target, and the own device, or an index for the identification by inputting each input feature of the input features of the plurality of wireless communication units to a generated individual management model for each of the fixed terminal or each of the position estimation target, for each wireless communication unit of the own device, or for a plurality of wireless communication units selected from the wireless communication units of the fixed terminal, the position estimation target, or the own device.

A management program according to an aspect of the present invention causes a computer to function as the above management device.

### Advantageous Effects of Invention

According to the present invention, it is possible to provide a technology capable of managing a state of an individual wireless communication terminal (a fixed terminal, or a position estimation target) that transmits a wireless signal or an individual wireless communication unit of an own device that receives the wireless signal in a position estimation device that estimates a position of a position estimation target using a plurality of pieces of channel information.

### BRIEF DESCRIPTION OF DRAWINGS

FIG. 1 is a diagram illustrating an overall configuration of a wireless communication system according to the present embodiment.

FIG. 2 is a diagram illustrating a configuration of a position estimation model management unit.

FIG. 3 is a diagram illustrating an operation of the management device.

FIG. 4 is a diagram illustrating an experimental environment area.

FIG. 5 is a diagram illustrating a division example of an experimental environment area.

FIG. 6 is a diagram illustrating a measurement result of a position estimation error.

FIG. 7 is a diagram illustrating a hardware configuration of the management device.

### DESCRIPTION OF EMBODIMENTS

Hereinafter, an embodiment of the present invention will be described with reference to the drawings. In the drawings, the same parts are denoted by the same reference signs, and description thereof is omitted.

### SUMMARY OF INVENTION

The present invention converts a plurality of pieces of channel information into a plurality of input features that can be input to a machine learning model, and inputs each input feature of the converted plurality of input features to each individual management model of machine learning generated for each wireless communication terminal (a fixed terminal, a position estimation target) that transmits a wireless signal, each wireless communication unit of an own device that receives the wireless signal, or each of a plurality of wireless communication units selected from a plurality of wireless communication units and arbitrarily combined, thereby identifying normality or abnormality of each wireless communication terminal (a fixed terminal, a position estimation target) or each wireless communication unit of the own device, or outputting an index for identification. That is, in a case where position estimation is performed by using a plurality of fixed terminals such as a wireless base station that is fixedly installed (by using a plurality of pieces of channel information), in order to detect that any fixed terminal is shifted or failed, monitoring is performed while using individual pieces of channel information at the same time.

As described above, the present invention identifies whether the wireless communication terminal or the wireless communication unit is abnormal or outputs the index for the identification by the individual management model that generates in advance the input feature generated from the channel information for each individual wireless communication terminal or each individual wireless communication unit that has received the wireless signal, or for each of the plurality of wireless communication units selected from the plurality of wireless communication units and arbitrarily combined. Therefore, the present invention can provide a technology capable of individually managing the state of the wireless communication terminal or the wireless communication unit of the own device.

Note that the channel information is information regarding how radio waves propagate between the wireless communication terminal on the transmission side and the wireless communication terminal on the reception side, and the communication quality of wireless communication. For example, that is information related to reception power and a radio wave propagation coefficient in wireless communication, a channel matrix representing a state of radio wave propagation between a plurality of antennas included in a wireless communication terminal on a transmission side and a plurality of antennas included in a wireless communication terminal on a reception side in a MIMO (Multiple Input Multiple Output) communication technology, and signal-to-noise interference power.

The input feature is a feature of channel information obtained by converting the channel information to be input into a machine learning model. For example, the input feature is channel information itself that is not converted or a numerical value obtained by performing various calculations on the channel information. For example, that is a value obtained by normalizing one or more values of feature of a phase, an amplitude, a real component, an imaginary component, and a range of coefficient of the one or more values, among features related to reception power of the wireless signal, signal power, power ratio information obtained from a moving average of reception power and signal power, a channel matrix including radio wave propagation coefficients between a plurality of antennas, a correlation matrix of the channel matrix, an arithmetic matrix obtained by signal processing of the channel matrix, an arithmetic matrix obtained by signal processing of the correlation matrix, an arithmetic matrix obtained by signal processing of the channel matrix or an arithmetic matrix corresponding to a plurality of frequencies, a unitary matrix obtained by linear operation of the channel matrix, a unitary matrix obtained by linear operation of the correlation matrix, a unitary matrix obtained by linear operation of the arithmetic matrix, a diagonal matrix obtained by linear operation of the channel matrix, a diagonal matrix obtained by linear operation of the correlation matrix, a diagonal matrix obtained by linear operation of the arithmetic matrix, a triangular matrix obtained by linear operation of the channel matrix, a triangular matrix obtained by linear operation of the correlation matrix, and a triangular matrix obtained by linear operation of the arithmetic matrix.

The position estimation target is a movable object located in the same environment as the wireless communication terminal. The position of the position estimation target is, for example, a position on a route on which the position estimation target is moving, a position in a two-dimensional space (a map or the like), or a position in a three-dimensional space. In addition to these pieces of position information, a more detailed physical state such as orientation and speed may be further estimated.

### [Overall Configuration of Wireless Communication System]

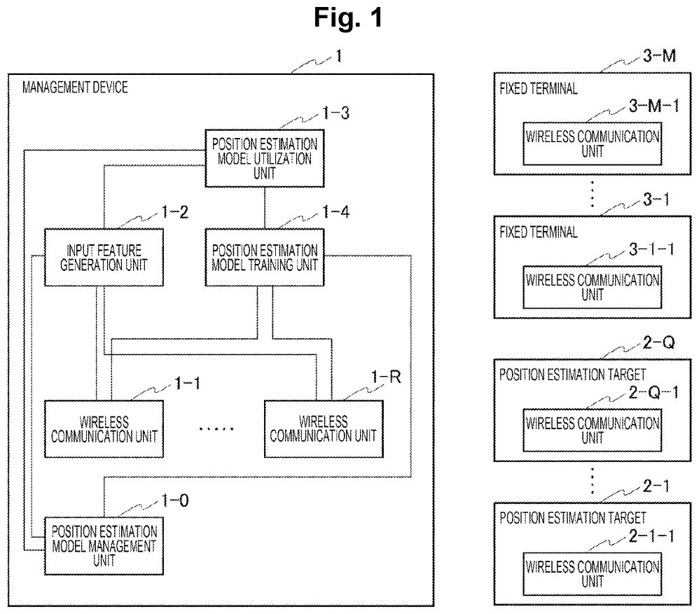

FIG. 1 is a diagram illustrating an overall configuration of a wireless communication system according to the present embodiment.

The wireless communication system includes a management device 1, fixed terminals 3-1 to 3-M, and position estimation targets 2-1 to 2-Q.

The management device 1 is a position estimation device that estimates positions of the position estimation targets 2-1 to 2-Q, and is a management device that manages states of the fixed terminals 3-1 to 3-M that transmit wireless signals, the position estimation targets 2-1 to 2-Q that transmit wireless signals, and the wireless communication units 1-1 to 1-R of the own device that receive wireless signals.

The management device 1 collects channel information of a wireless signal transmitted from at least one fixed terminal among the plurality of fixed terminals 3-1 to 3-M, thereby estimating a position of at least one position estimation target among the plurality of position estimation targets 2-1 to 2-Q located in the same environment as the fixed terminals 3-1 to 3-M. In addition, the management device 1 further collects channel information of a wireless signal transmitted from at least one position estimation target among the plurality of position estimation targets 2-1 to 2-Q, thereby estimating the position of at least one position estimation target among the plurality of position estimation targets 2-1 to 2-Q. The management device 1 can estimate the position of the position estimation target by using only the channel information of the fixed terminal, and can estimate the position of the position estimation target by further using the channel information of the position estimation target.

The fixed terminals 3-1 to 3-M include wireless communication units 3-1-1 to 3-M-1. One fixed terminal includes one or more wireless communication units. The position estimation targets 2-1 to 2-Q may include the wireless communication units 2-1-1 to 2-Q-1, or may be mere position estimation targets without a wireless communication unit. A wireless communication unit used for position estimation included in the fixed terminals 3-1 to 3-M and the position estimation targets 2-1 to 2-Q is defined as a terminal or a wireless communication unit of a wireless communication terminal. One position estimation target may include one or more wireless communication units. Each of the wireless communication units 3-1-1 to 3-M-1 and the wireless communication units 2-1-1 to 2-Q-1 transmits a pilot signal to be known in transmission and reception or a wireless signal including channel information with an arbitrary wireless communication unit. The arbitrary wireless communication units are the wireless communication units 1-1 to 1-R (R is an integer of 1 or more) provided in the management device 1, or other wireless communication units.

The management device 1 described in the present embodiment is applied to a case where the management device 1 includes wireless communication units (3-i-1 or 2-j-1) of a plurality of terminals or a plurality of own wireless communication units (1-1 to 1-R). At least one of the number of wireless communication units (3-i-1 or 2-j-1) of the terminal and the number of wireless communication units (1-1 to 1-R) of the management device 1 is plural. In a case where there is one wireless communication unit of the terminal, it is possible to confirm whether or not any of the plurality of own wireless communication units (1-1 to 1-R) is abnormal. In a case where there is one wireless communication unit (any one of 1-1 to 1-R) of the own, it is possible to confirm whether or not there is an abnormality in the wireless communication units (3-i-1 or 2-j-1) of the terminal. In a case where the number of wireless communication units of both the terminal and the own are plural, it is possible to confirm abnormalities of the wireless communication units of both the management device 1 and the terminal.

The management device 1 receives wireless signals from a wireless communication unit (3-i-1 (1≤i≤M) or 2-j-1 (1≤j≤Q)) of one or more terminals via the wireless communication units 1-1 to 1-R. Alternatively, the management device 1 receives wireless signals from the wireless communication units of one or more terminals via the wireless communication units 1-1 to 1-R.

Then, the management device 1 acquires a plurality of pieces of channel information between the wireless communication units (3-i-1 or 2-j-1) of one or more terminals and arbitrary own wireless communication units 1-1 to 1-R from the plurality of received wireless signals.

Then, the management device 1 inputs the plurality of acquired pieces of channel information to the input feature generation unit 1-2. The input feature generation unit 1-2 converts the plurality of pieces of channel information into a plurality of input features suitable for input to the machine learning model, and inputs the plurality of converted input features to the position estimation model utilization unit 1-3.

Thereafter, the position estimation model utilization unit 1-3 estimates the position of position estimation target 2-j by inputting the input features of a plurality of pieces of channel information collected from the wireless communication unit (fixed terminal 3-i or position estimation target 2-j) of one or more terminals to the position estimation model obtained by modeling, by machine learning, the relationship between the position information of the position estimation target and the input features of the channel information.

Thereafter, the position estimation model management unit 1-0 uses the individual input feature corresponding to the channel information of the wireless communication unit of the individual terminal among the plurality of pieces of channel information generated by the input feature generation unit 1-2 to determine whether the fixed terminal or the position estimation target is normal or abnormal, and outputs an index for determining abnormality.

Specifically, the position estimation model management unit 1-0 inputs each input feature of the plurality of input features corresponding to the channel information of the wireless communication unit of the terminal generated by the input feature generation unit 1-2 to an individual management model of the machine learning generated in advance corresponding to a plurality of combinations of, for each wireless communication unit of the terminal that has transmitted the wireless signal, or for each wireless communication unit 1-r (1≤r≤R) of the own device that has received the wireless signal, or the wireless communication unit of the terminal that has transmitted or of the own device, thereby identifying normality or abnormality of the wireless communication unit (3-i-1 or 2-j-1) of the terminal or each wireless communication unit 1-r of the own device, or outputting an index for determining abnormality.

### [Configuration of Fixed Terminal]

The fixed terminal 3-i includes a wireless communication unit 3-i-1 and is a wireless communication terminal installed in a predetermined environment. The fixed terminal 3-i is desirably fixed to, for example, a wall, a floor, a ceiling, or the like so as not to move. The fixed terminal 3-i may be realized by using a special dedicated device, or may be realized by using an arbitrary terminal with a built-in wireless communication unit such as a smartphone or a PC. One fixed terminal 3-i may include a plurality of wireless communication units 3-i-1. A plurality of fixed terminals 3-i may be provided.

### [Configuration of Position Estimation Target]

When the position estimation target 2-j includes the wireless communication unit 2-j-1, the mobile wireless communication terminal is located in the same environment as the fixed terminal 3-i and is a position estimation target. For example, the position estimation target 2-j is an autonomous running robot. Since the management device 1 can estimate the position of the position estimation target 2-j using only the channel information of the fixed terminal 3-j, the position estimation target 2-j does not need to include the wireless communication unit 2-j-1. One position estimation target 2-j may include a plurality of wireless communication units 2-j-1. A plurality of the position estimation targets 2-j may be provided.

### [Configuration of Management Device]

The management device 1 is, for example, a base station installed in a main place. The management device 1 may have any configuration including a wireless communication unit capable of communicating with the fixed terminal 3-i and the position estimation target 2-j or a wireless communication unit capable of decoding a wireless signal transmitted from the fixed terminal 3-i and the position estimation target 2-j. The management device 1 does not necessarily need a function of transmitting a wireless signal. In the management device 1, it is desirable that the antenna units of the wireless communication units 1-1 to 1-R are fixed in order to improve the position estimation accuracy.

As illustrated in FIG. 1, the management device 1 includes, for example, wireless communication units 1-1 to 1-R, an input feature generation unit 1-2, a position estimation model utilization unit 1-3, a position estimation model training unit 1-4, and a position estimation model management unit 1-0.

The wireless communication units 1-1 to 1-R are communication units that perform wireless communication or receive wireless signals. The wireless communication units 1-1 to 1-R may correspond to a plurality of frequencies, a plurality of frequency bands, or a plurality of wireless communication systems. FIG. 1 illustrates a configuration in which wireless communication units 1-1 to 1-R receive wireless signals transmitted from M fixed terminals 3-1 to 3-M.

Any one of the wireless communication units 1-1 to 1-R may be a base station that communicates with a wireless communication unit (3-i-1 or 2-j-1) of the terminal. For example, the wireless communication unit of the terminal may communicate with an arbitrary base station not illustrated in FIG. 1 and receive a wireless signal transmitted to the arbitrary base station by itself. The configuration may be a combination of them. Since the wireless communication units 1-1 to 1-R on the reception side can decode wireless signals at a single carrier frequency, the wireless communication unit of the terminal may transmit the wireless signals at the same frequency to reduce the complexity of the circuits of the wireless communication units 1-1 to 1-R. The same applies to the position estimation targets 2-1 to 2-Q.

The plurality of wireless communication units 1-1 to 1-R have a function of receiving a plurality of wireless signals transmitted from the plurality of wireless communication units 3-1-1 to 3-M-1 of one or more fixed terminals 3-1 to 3-M, acquiring a plurality of pieces of channel information related to radio wave propagation between the fixed terminal 3-i and the management device 1 from the plurality of received wireless signals, or acquiring a plurality of pieces of channel information related to radio wave propagation between a wireless communication device other than the fixed terminal 3-i and the management device 1. When acquiring a plurality of pieces of channel information corresponding to the fixed terminal 3-i, the wireless communication units 1-1 to 1-R input the acquired plurality of pieces of channel information to the input feature generation unit 1-2.

In addition, the plurality of wireless communication units 1-1 to 1-R has a function of receiving a plurality of wireless signals transmitted from any plurality of wireless communication units including at least the wireless communication unit of the fixed terminal among the wireless communication units 3-1-1 to 3-M-1 of the fixed terminals 3-1 to 3-M and the wireless communication units 2-1-1 to 2-Q-1 of the position estimation targets 2-1 to 2-Q, and acquiring channel information on radio wave propagation between the wireless communication unit (3-i-1 or 2-j-1) of the terminal and the management device 1 from the received plurality of wireless signals. When acquiring a plurality of pieces of channel information corresponding to the fixed terminal 3-i or the fixed terminal 3-i and the position estimation target 2-j, the wireless communication units 1-1 to 1-R input the acquired plurality of pieces of channel information to the input feature generation unit 1-2.

The input feature generation unit 1-2 has a function of converting the plurality of pieces of input channel information into a plurality of input features that can be input to the machine learning model. The input feature generation unit 1-2 inputs the input feature of the plurality of pieces of channel information after the conversion to the position estimation model utilization unit 1-3 and the position estimation model management unit 1-0.

The position estimation model utilization unit 1-3 has a function of estimating and calculating the position of the position estimation target 2-j based on a plurality of pieces of channel information by inputting a plurality of input features that has been input to a position estimation model obtained by modeling, by machine learning, a relationship between channel information related to radio wave propagation and position information of the position estimation target 2-j.

In this manner, the position estimation model utilization unit 1-3 calculates the position of the position estimation target 2-j on the basis of the channel information. Here, in a case where the position information is calculated on the basis of the channel information, it is necessary to obtain high estimation accuracy that there is no change in antenna conditions such as the position, orientation, and directivity of the fixed terminal 3-i, and the circuit configuration and setting contents of the wireless communication unit 3-i-1 of the fixed terminal 3-i and the wireless communication unit 1-r of the management device 1. This is because reproducibility is required for a relationship between data to which a model generated by machine learning is input and output.

Similarly, the wireless communication unit 1-r of the management device 1 also needs to be static and unchanged. When a position is shifted, an antenna orientation or a connection condition is changed, or a problem occurs in a circuit of the wireless communication unit 3-i-1 of the fixed terminal 3-i or the wireless communication unit 1-r of the management device 1, a relationship between channel information and position information changes, and the position estimation model cannot output correct position information. In particular, in a case where the channel information is acquired from the wireless communication units of the plurality of terminals, or the channel information is received by the wireless communication units 1-r (r≥2) of the plurality of management devices 1, or both of them, it is difficult to distinguish the reason why the accuracy of the position information is deteriorated.

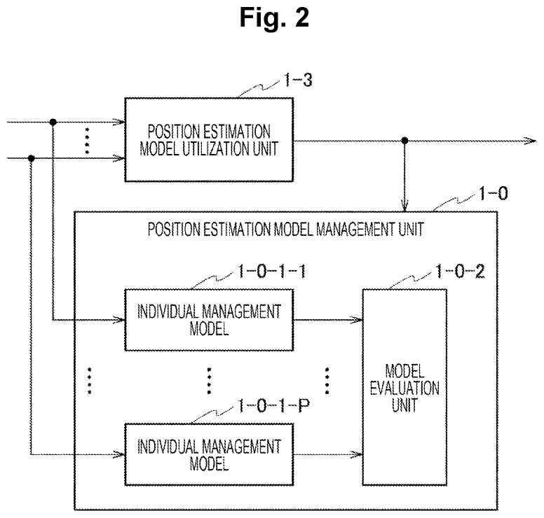

As illustrated in FIG. 2, the position estimation model management unit 1-0 includes a plurality of individual management models 1-0-1-1 to 1-0-1-P and a model evaluation unit 1-0-2. The position estimation model management unit 1-0 outputs information for determining an abnormality in the input features that have been input, by an individual management model learned in advance, using only input features corresponding to the individual wireless communication unit 3-i-1 of the fixed terminal 3-i that has transmitted a wireless signal, the individual wireless communication unit 2-j-1 of the position estimation target 2-j that has transmitted a wireless signal, the individual wireless communication unit 1-r of the own device that has received a wireless signal, or a plurality of combinations (a plurality of wireless communication units) selected from the fixed terminal 3-i, the position estimation target 2-j, and the wireless communication unit 1-r, among the input features of the plurality pieces of channel information generated by the input feature generation unit 1-2, and identifies, in the model evaluation unit 1-0-2, using an output from the individual management model, whether there is an abnormality in the wireless communication unit corresponding to the input feature, and outputs an index for identifying the abnormality. For example, by using the individual management model as the position estimation model, the position information of at least one position estimation target 2-j among the position estimation targets 2-1 to 2-P can be output, and the model evaluation unit 1-0-2 can identify whether the wireless communication unit is in the normal state or the abnormal state and output an index for identifying the abnormality.

In a case where the position information is output from the individual management models 1-0-1-1 to 1-0-1-P as the information for identifying the abnormality, the model evaluation unit 1-0-2 can temporarily store the output result of the position information in the storage unit, read the position information from the storage unit at a predetermined timing, and compare the read position information with accurate position information of the position estimation target 2-j separately prepared to evaluate offline whether or not the output result of the position information is correct.

Alternatively, the model evaluation unit 1-0-2 compares the output result of the position information by the position estimation model utilization unit 1-3 with the output result of the position information predicted using the position estimation model generated as the individual management model from the relationship between the input feature and the position information corresponding to the individual wireless communication unit. Then, it is possible to evaluate in real time whether the output of any of the individual management models is an inaccurate value that greatly deviates, and by including three or more individual management models, detect an individual management model that greatly deviates from the output from other individual management models or behaves differently, output identification of abnormality or an index for identifying abnormality from the individual management model by an abnormality detection algorithm studied as a machine learning technology, and detect abnormality of the wireless communication unit or output an index for identifying the abnormality in the model evaluation unit. For example, a deviation from a characteristic of data at a normal time is output as a value, and another system or a human can separately determine an abnormality or analyze a type or a characteristic of the abnormality on the basis of the output value.

In the identification of the abnormality of the wireless communication unit, if the input feature is the one which the individual management model corresponds to the single wireless communication unit, the index regarding that the wireless communication unit corresponding to the individual management model is abnormal or the suspicion of the abnormality can be output. If the input feature is the one which the individual management model corresponds to a plurality of wireless communication units, to the wireless communication unit to which the individual management model identifying the abnormality and outputting the index strongly suspected of the abnormality corresponds, an index of the abnormality or the suspicion of the abnormality can be output. For example, if the outputs of the plurality of individual management models indicate abnormality and there is a wireless communication unit commonly included in the input feature to be used, it can be identified that the wireless communication unit is highly likely to output an abnormal value.

In the comparison with the output from the position estimation model utilization unit 1-3 described above, it is also assumed that the result of the position estimation model itself greatly deviates due to any wireless communication unit outputting abnormality data. Therefore, similarly to the outputs of the individual management models 1-0-1-1 to 1-0-1-P, abnormality detection by machine learning may be applied to the output of the position estimation model utilization unit 1-3, and the cause of the abnormality may be analyzed in more detail using the individual output from the individual management model. For example, the cause of the abnormality may be analyzed using a relationship with time or information other than information of the management device according to the present invention.

Each of the plurality of individual management models 1-0-1-p (1≤p≤P) can be a position estimation model obtained by modeling, by machine learning, the relationship between the input feature generated from the channel information of the wireless communication unit (3-i-1 or 2-j-1) of one terminal or one wireless communication unit 1-r of the own device and the position information of the position estimation target 2-j. Each individual management model 1-0-1-p receives an input feature corresponding to one wireless communication unit and outputs position information of the position estimation target 2-j.

Alternatively, the individual management model may use a position estimation model trained to output the position information from the input feature generated from the channel information of the wireless communication units (3-i-1 or 2-j-1) of the plurality of terminals or the plurality of wireless communication units 1-r.

By using the input features corresponding to the wireless communication units of the plurality of terminals (fixed terminal, position estimation target) and the plurality of wireless communication units for the individual management model, the accuracy of the information to be output for identifying the abnormality can be enhanced. In the example in which the position estimation model is used as the individual management model, if the position prediction is performed from a single wireless communication unit, the position prediction accuracy is low, and it may be difficult to identify the abnormality. Even in a case where a quantified abnormality degree is output by abnormality detection, if reproducibility of input information is high, accuracy of abnormality determination can be expected to be improved. As a disadvantage, in a case where an individual management model corresponding to a plurality of wireless communication units is provided, there is a possibility not to specify which wireless communication terminal has an abnormality. However, in addition to understanding that at least one of some wireless communication terminals is abnormal, preparing an individual management model that outputs position information from input features of various combinations of wireless communication terminals makes it possible to specify the wireless communication terminal with the abnormality.

The model evaluation unit 1-0-2 has a function of comparing the position information of the position estimation target 2-j estimated from the channel information corresponding to the one wireless communication unit that has been input with the position information of the position estimation target 2-j estimated using the channel information corresponding to the plurality of wireless communication units output by the position estimation model utilization unit 1-3, and identifying that the wireless communication unit corresponding to the input channel information is abnormal or outputting an index for identifying abnormality when a difference (error) between the two pieces of compared position information exceeds a threshold value or when an error tendency satisfies a specific condition. For example, the model evaluation unit 1-0-2 specifies position information of a value that is an outlier in a set of a plurality pieces of position information as abnormal, outputs an index for identifying a deviation of the value from the set as abnormal, or outputs a degree of outlier (outlier level).

In a case where the abnormality detection algorithm of the machine learning is used as the individual management model 1-0-1, the individual management model of the abnormality detection algorithm can be constructed using the data in the normal state that is the input feature generated from the channel information of one or more wireless communication devices of the fixed terminal 3-i or the position estimation target 2-j, and the wireless communication unit 1-r of the own device. The abnormality detection algorithm can detect deviation from a normal pattern grasped in advance by learning the data series in the normal state. Alternatively, a specific abnormality may be detected using data in which the positions of the wireless communication unit and the antenna are shifted, abnormality data such as failure of the device, and pseudo abnormality data created in advance on the assumption of these abnormalities. The model evaluation unit 1-0-2 receives the information regarding the abnormality from the individual management model, and can output abnormality identification and an index used for identification regarding which wireless communication unit has what kind of abnormality.

That is, the channel information of the wireless communication unit (each wireless communication unit of fixed terminal, position estimation target, and management device) at the normal time may be given to generate the abnormality detection algorithm in advance. For example, in a case where each individual management model receives an input feature related to a single wireless communication unit, the model evaluation unit 1-0-2 can detect a wireless communication unit corresponding to an individual management model that outputs an abnormality identification or an index indicating an abnormality as an abnormal state.

Further, the position information which is the output of the position estimation model utilization unit 1-3 may together be input to the individual management model 1-0-1 or the model evaluation unit 1-0-2. Alternatively, information effective for identifying an abnormality other than the management device 1 according to the present invention may be simultaneously input. By inputting an acquirable parameter that affects the channel information (for example, temperature, humidity, time, degree of congestion, position information of an object, state information of a structure, and the like) to the position estimation model, it is possible to improve accuracy of position prediction, abnormality detection based on the position prediction, and abnormality detection of the input feature. For example, in a case where the position estimation model is used as the individual management model 1-0-1, the model evaluation unit 1-0-2 can identify the abnormality by comparing the output position information with the position information predicted by the position estimation model utilization unit 1-3.

In addition, instead of separately generating an individual management model, the individual management model may be a part of the position estimation model in the position estimation model utilization unit 1-3. For example, assuming that the position estimation model is a neural network based on deep learning constructed using the channel information corresponding to all the wireless communication units, a layer using only the input features from the individual wireless communication units may be provided as the intermediate layer, and training may be performed so that the output of the intermediate layer converges to the position prediction result using the input features from specific wireless communication units, thereby causing a part of the position estimation model to function as the individual management model.

Note that the position estimation model used by the position estimation model utilization unit 1-3 and the individual management model included in the position estimation model management unit 1-0 (position estimation model, abnormality detection algorithm) may be a model generated in advance, or may be updated with newly generated data by fine tuning, transfer learning, or the like. In a case where the position estimation model is used as the individual management model, a model generated and updated by the position estimation model training unit 1-4 may be used. The position estimation model is a position estimation model generated by training, by machine learning, the relationship between the position information of the position estimation target 2-j located in the same environment as the fixed terminal 3-i and the channel information (≈ input feature) related to radio wave propagation acquired from the fixed terminal 3-i or the position estimation target 2-j. In addition, the position estimation model may be generated by generating a space equivalent to the real space in a simulation space using the digital twin technology or the like, and using the relationship between a virtually generated position estimation target and the channel information calculated by the simulation. As the position estimation model, a position estimation model created from a relationship between channel information and a position estimation target measured by another position estimation unit may be used.

The position estimation model training unit 1-4 has a function of generating a position estimation model by separately acquiring data regarding position information of the position estimation target 2-j and training an estimated position estimation model capable of estimating the position of the position estimation target 2-j on the basis of a relationship between the acquired position information and channel information. In addition, the position estimation model training unit 1-4 further has a function of updating the generated position estimation model. As a method of updating, for example, fine tuning and transfer learning known in deep learning can be used.

The position information of the position estimation target 2-j may be acquired by periodically collecting position measurement data by a position measurement function mounted on the position estimation target 2-j by some means. In addition, it is possible to estimate and learn the relationship between the position information of the position estimation target 2-j and the channel information obtained from the fixed terminal 3-i by using a predetermined machine learning model. The some means is a sensor, a camera, wireless positioning, simultaneous localization and mapping (SLAM), global positioning system (GPS), or the like mounted on the position estimation target 2-j. The management device 1 stores the position and time information of the position estimation target 2-j obtained by the position estimation target 2-j in the storage unit, and periodically and collectively inputs the position and time information to the position estimation model training unit 1-4, so that it can be used as teacher data for training the position estimation model.

The position estimation model training unit 1-4 can train the position estimation model by comparing the input position and time information of the position estimation target 2-j with the channel information and time information stored in the same storage unit on the same time axis to learn the relationship between them. Alternatively, the position estimation model training unit 1-4 can train the position estimation model by acquiring the position information of the position estimation target 2-j from information such as a camera, a sensor, and wireless positioning mounted on the management device 1 and learning the relationship with the channel information of the same time and the same time zone.

### [Operation of Management Device]

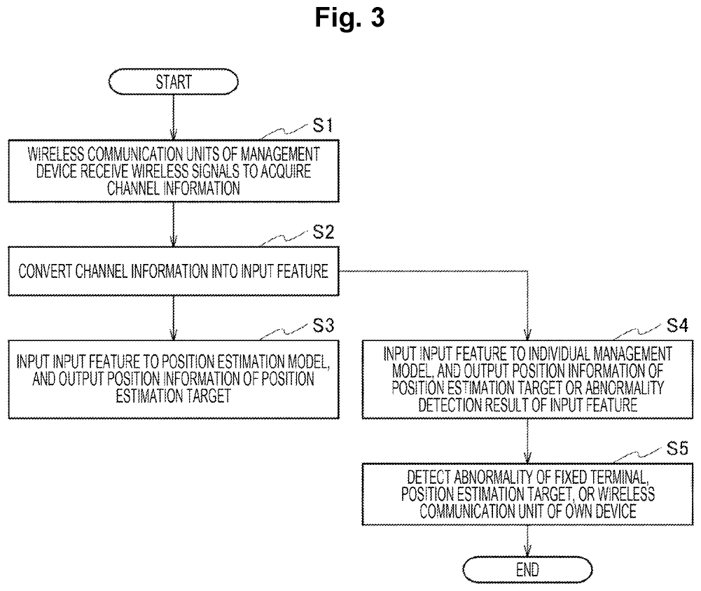

FIG. 3 is a diagram illustrating an operation of the management device 1.

It is possible to manage whether or not an abnormality occurs in any of the wireless communication devices while performing wireless communication between wireless communication units (3-i-1 or 2-j-1) of a plurality of terminals and the wireless communication unit of the management device 1 in advance, receiving wireless signals corresponding to the plurality of wireless communication units, and outputting a position of a position estimation target.

First, the wireless communication units 1-1 to 1-R of the management device 1 receive wireless signals transmitted from one or more wireless communication units included in the fixed terminal 3-i or the fixed terminal 3-i and the position estimation target 2-j, and acquire channel information corresponding to the wireless communication unit of the terminal from the received wireless signals (step S1). Here, the management device 1 according to the present invention functions either in a case where the number of acquired wireless communication units is plural, or in a case where the number of wireless communication units of the management device 1 is plural.

Next, the input feature generation unit 1-2 converts the acquired channel information corresponding to the wireless communication unit into an input feature suitable for input to the position estimation model, and inputs the input feature to the position estimation model utilization unit 1-3 and the position estimation model management unit 1-0 (step S2). The input feature is, for example, a value obtained by normalizing one or more values of feature of a phase, an amplitude, a real component, an imaginary component, and a range of coefficient of the one or more values, among features related to reception power of the wireless signal, signal power, power ratio information obtained from a moving average of reception power and signal power, a channel matrix including radio wave propagation coefficients between a plurality of antennas, a correlation matrix of the channel matrix, an arithmetic matrix obtained by signal processing of the channel matrix, an arithmetic matrix obtained by signal processing of the correlation matrix, an arithmetic matrix obtained by signal processing of the channel matrix or an arithmetic matrix corresponding to a plurality of frequencies, a unitary matrix obtained by linear operation of the channel matrix, a unitary matrix obtained by linear operation of the correlation matrix, a unitary matrix obtained by linear operation of the arithmetic matrix, a diagonal matrix obtained by linear operation of the channel matrix, a diagonal matrix obtained by linear operation of the correlation matrix, a diagonal matrix obtained by linear operation of the arithmetic matrix, a triangular matrix obtained by linear operation of the channel matrix, a triangular matrix obtained by linear operation of the correlation matrix, and a triangular matrix obtained by linear operation of the arithmetic matrix. A specific method of calculating the input feature will be described later.

Next, the position estimation model utilization unit 1-3 inputs the converted input feature to the position estimation model, thereby estimating and calculating position information of the position estimation target 2-j based on the channel information and outputting the position information (step S3).

In addition, the position estimation model management unit 1-0 separates the input feature for each individual wireless communication unit, estimates and calculates the position information of the position estimation target 2-j using the position estimation model trained to perform the position estimation of the position estimation target 2-j with the input feature corresponding to each wireless communication unit in the individual management models 1-0-1-1 to 1-0-1-P, and outputs the position information to the model evaluation unit 1-0-2. Alternatively, in the individual management model, an index representing the degree of abnormality is output using the abnormality detection algorithm for the input feature corresponding to each wireless communication unit (step S4).

Thereafter, the model evaluation unit 1-0-2 determines whether there is an abnormality in the position estimation model corresponding to any one of the wireless communication units from the estimation result of the position information of the position estimation target 2-j using the input feature based on the channel information of the individual wireless communication unit or the result of the abnormality detection, and outputs an index for identifying the abnormality (step S5). In a case where the estimation result of the position information is used, in the model evaluation unit 1-0-2, the position estimation result in step S3 may be used, the wireless communication terminal outputting the shifted position information may be detected from the comparison of the outputs of three or more individual management models, the measurement result of the position information of the position estimation target 2-j separately acquired may be used, an acquirable parameter affecting the channel information described above may be used, or the abnormality detection may be performed on the estimation result of the position information input using the algorithm of the abnormality detection by the machine learning. In addition, the type of the abnormality may be determined based on the input from the individual management model.

### [Method for Collecting Channel Information, and Method for Calculating Input Feature]

An example of a method for collecting channel information and a method for calculating an input feature will be described below.

### [Method for Collecting Channel Information, and Method for Calculating Input Feature (First Example)]

In the first method, the fixed terminal 3-i or the position estimation target 2-j transmits a pilot signal to be known in transmission and reception. By transmitting the known pattern in advance, the wireless communication unit 1-r of the management device 1 can acquire the channel matrix between the antenna (the number of reception antennas: Mr) of its own wireless communication unit 1-r and the antenna (the number of transmission antennas: Ni) of the wireless communication unit 3-i-1 or the wireless communication unit 2-j-1 that has transmitted the pilot signal. The orthogonal wave division multiplexing (OFDM) used in various wireless communication systems can obtain a channel matrix of subcarriers corresponding to a plurality of frequencies.

An input feature to be input to the position estimation model utilization unit 1-3 is generated from the channel matrix H of “the number of transmission antennas Ni×the number of reception antennas Mr” obtained in this manner. For example, in a case where a channel matrix is obtained for a plurality of subcarriers by OFDM, the channel matrix of the ηth subcarrier is defined as H_{η}. Then, as a method of converting into the input feature, first, the channel matrix H_{η} is separated into a normalized channel matrix G_{η} normalized by a predetermined norm and amplitude information γ_{η} or power information γ_{η}² as in Formula (1).

$$\begin{matrix}[ Formula 1 ] & \\ {H}_{η} = {γ}_{η} {G}_{η} & ( 1 )\end{matrix}$$

For example, G_{η} can be set such that ∥G_{η}∥_{F}=1. ∥·∥_{F} represents frobenius norm. Y_{η} generally has a large fluctuation range, and there may be a change of 10 to the power of 5 or more. Therefore, a value obtained by converting γ_{η} and γ_{η}² into dB, defining the maximum value and the minimum value, and expressing the range with a value normalized within a range of 0 to 1 or the like may be used. Values γₐₗₗ selected multiple pieces or averaged for different frequency conditions or antenna conditions may be used.

In addition, as in Formula (2), the amplitude information γ_{η} may be separated for each antenna, and each column vector g_{1, η} to g_{Mr, η} obtained by normalizing the norm value to a certain value and its amplitude value γ_{1, η} to γ_{Mr, η} may be obtained.

$$\begin{matrix}[ Formula 2 ] & \\ {H}_{η} = ( {g}_{1 , η} … {g}_{Mr , η} ) ( \begin{matrix}{γ}_{1 , η} & 0 & 0 \\ 0 & ⋱ & 0 \\ 0 & 0 & {γ}_{Mr , η}\end{matrix} ) & ( 2 )\end{matrix}$$

For example, g_{a, η} can be set as a specified vector such that ∥g_{a, η}∥_{F}=1. A value obtained by converting γ_{a,η} and γ_{a,η}² into dB, defining the maximum value and the minimum value, and expressing the range with a value normalized within a range of 0 to 1 or the like may be used. This applies to a value γ_{a, all} corresponding to the ath column vector selected multiple pieces or averaged with respect to η.

In addition, as in Formula (3), the amplitude information γ_{η} may be separated for each antenna, and each row vector g′_{1,η} to g′_{Ni,η} obtained by normalizing the norm value to a certain value and its amplitude value γ′_{i, η} to γ′_{Ni,η} may be obtained.

$$\begin{matrix}[ Formula 3 ] & \\ {H}_{η} = ( \begin{matrix}{γ}_{1 , η}^{′} & 0 & 0 \\ 0 & ⋱ & 0 \\ 0 & 0 & {γ}_{Ni , η}^{′}\end{matrix} ) ( \begin{matrix}{g}_{1 , η}^{′} \\ ⋮ \\ {g}_{Ni , η}^{′}\end{matrix} ) & ( 3 )\end{matrix}$$

For example, g′_{b,η} can be set as a specified vector such that ∥g′_{b,η}∥_{F}=1. A value obtained by converting γ′_{b,η} and γ′_{b,η}² into dB, defining the maximum value and the minimum value, and expressing the range with a value normalized within a range of 0 to 1 or the like may be used. This applies to a value γ′_{b,all} corresponding to the bth column vector selected multiple pieces or averaged with respect to η.

The channel matrix H_{η}, the normalized channel matrix G_{η}, the normalized vectors g_{a, η}, and the normalized vectors g′_{b, η} can use the real part and the imaginary part of each element as input features, can use the real part and the imaginary part as input information without change, can be converted into another format such as angle information, or can be quantized.

In addition, correlation matrices H_{η}H_{η}^{H} and H_{η}^{H}H_{η} generated using the channel matrix H_{η} can be used. Correlation matrices G_{η}G_{η}^{H} and G_{η}^{H}G_{η} generated using the channel matrix G_{η} can be used. A matrix ΣH_{η}, ΣG_{η}, ΣH_{η}H_{η}^{H}, ΣH_{η}^{H}H_{η}, ΣG_{η}G_{η}^{H}, or ΣG_{η}^{H}G_{η} obtained by summing or averaging the channel matrix H_{η}, the normalized channel matrix G_{η}, and the correlation matrices H_{η}H_{η}^{H}, H_{η}^{H}H_{η}, G_{η}G_{η}^{H}, and G_{η}^{H}G_{η} with respect to a plurality of frequencies can be used. An eigenvalue, a diagonal matrix, and a unitary matrix obtained by performing QR decomposition, singular value decomposition (SVD), eigenvector decomposition, or the like of these matrices can be used.

Further, by using the matrices ΣH_{η}, ΣG_{η}, ΣH_{η}H_{η}^{H}, ΣH_{η}^{H}H_{η}, ΣG_{η}G_{η}^{H}, and ΣG_{η}^{H}G_{η}, the power characteristic with respect to the arrival direction with respect to the communication device obtained by the arrival wave direction estimation technique may be used as the input feature. For example, a value obtained by multiplying each vector component by (1, exp(jdθ), exp(j2dθ), . . . , exp(jNdθ)) can be calculated for θ. θ up to 0 to 2π can be generated at an arbitrary angular interval, and an output for a plurality of θcan be used as the input feature. d is a predetermined constant. N is the number of elements of the vector.

In other words, the input feature generation unit 1-2 generates, as an input feature, a value obtained by normalizing one or more values of feature of a phase, an amplitude, a real component, an imaginary component, and a range of coefficient of the one or more values, among features related to reception power of the wireless signal, a channel matrix of channel information, a correlation matrix of the channel matrix, an arithmetic matrix obtained by signal processing of the channel matrix, an arithmetic matrix obtained by signal processing of the correlation matrix, an arithmetic matrix obtained by signal processing of the channel matrix or an arithmetic matrix corresponding to a plurality of frequencies, a unitary matrix obtained by linear operation of the channel matrix, a unitary matrix obtained by linear operation of the correlation matrix, a unitary matrix obtained by linear operation of the arithmetic matrix, a diagonal matrix obtained by linear operation of the channel matrix, a diagonal matrix obtained by linear operation of the correlation matrix, a diagonal matrix obtained by linear operation of the arithmetic matrix, a triangular matrix obtained by linear operation of the channel matrix, a triangular matrix obtained by linear operation of the correlation matrix, and a triangular matrix obtained by linear operation of the arithmetic matrix. The input feature generation unit 1-2 stores such input feature as time-series data, and outputs input feature corresponding to a plurality of times from the past to the present to the position estimation model.

In a wireless communication system using an equalization technology, it is possible to estimate an arrival time, power, and a phase condition of a path of an incoming electric signal. Even the channel information obtained in time series in this manner can be used as the input feature of the position estimation model by using the feature and the angle information extracted by the standardization of the power, the conversion into the frequency component, and the existing incoming wave direction technology.

### [Method for Collecting Channel Information, and Method for Calculating Input Feature (Second Example)]

In the second method, the fixed terminal 3-i or the position estimation target 2-j communicates with a specific wireless base station, estimates channel information from a pilot signal transmitted and received from the specific wireless base station, generates feedback information by performing quantization in some form, and transmits a wireless signal including the generated feedback information. The wireless communication unit 1-r of the management device 1 receives the wireless signal and acquires channel information between a specific wireless base station and the fixed terminal 3-i or the position estimation target 2-j included in the received wireless signal.

First, a pilot signal to be known in transmission and reception is transmitted from a specific wireless base station. By transmitting the known pattern in advance, the wireless communication unit 3-i-1 of the fixed terminal 3-i or the wireless communication unit 2-j-1 of the position estimation target 2-j can acquire a channel matrix between its own receiving antenna (the number of reception antennas: Ni) and the antenna of the specific wireless base station that has transmitted the pilot signal (the number of transmission antennas: Mt). The OFDM used in various wireless communication systems can obtain a channel matrix of subcarriers corresponding to a plurality of frequencies.

An input feature to be input to the position estimation model utilization unit 1-3 is generated from the channel matrix Ha of “the number of transmission antennas Mt×the number of reception antennas Ni” obtained in this manner. For example, in a case where a channel matrix is obtained for a plurality of subcarriers by OFDM, the channel matrix of the ηth subcarrier is defined as H_{α,η}. Here, when the specific wireless base station is the wireless communication unit 1-r of the management device 1, the number of transmission antennas Mt is equal to the number of reception antennas Mr defined for the wireless communication unit 1-r in the first method. Furthermore, in this case, the channel matrix H_{α, η} corresponds to a transposed matrix of the channel matrix H_{η}.

Then, as a method of converting into the input feature, as in the first method, the channel matrix H_{α,η} is separated into a normalized channel matrix G_{α,η} normalized by a predetermined norm and amplitude information γ_{α,η} or power information γ_{η}² as in Formula (4).

$$\begin{matrix}[ Formula 4 ] & \\ {H}_{α , η} = {γ}_{α , η} {G}_{α , η} & ( 4 )\end{matrix}$$

For example, G_{α,η} can be set such that ∥G_{α,η}∥_{F}=1. ∥·∥_{F} represents frobenius norm. A value obtained by converting γ_{α,η} and γ_{α,η}² into dB, defining the maximum value and the minimum value, and expressing the range with a value normalized within a range of 0 to 1 or the like may be used. A value γ_{α, all} selected multiple pieces or averaged may be used. To obtain γ_{α,all} by averaging, it may be averaged by a true value, may be averaged after being set to dB, or may be averaged by a true value in units of dB.

In addition, as in Formula (5), the amplitude information γ_{α,η} may be separated for each antenna, and each column vector g_{α,1,η} to g_{α,Ni,η} obtained by normalizing the norm value to a certain value and its amplitude value γ_{α,i,η} to γ_{α,Ni,η} may be obtained.

$$\begin{matrix}[ Formula 5 ] & \\ {H}_{α , η} = ( {g}_{α , 1 , η} … {g}_{α , Ni , η} ) ( \begin{matrix}{γ}_{α , 1 , η} & 0 & 0 \\ 0 & ⋱ & 0 \\ 0 & 0 & {γ}_{α , Ni , η}\end{matrix} ) & ( 5 )\end{matrix}$$

For example, g_{α,a,η} can be set as a specified vector such that ∥g_{α,a,η}∥_{F}=1. A value obtained by converting γ_{α,a,η} and γ_{α,a,η}² into dB, defining the maximum value and the minimum value, and expressing the range with a value normalized within a range of 0 to 1 or the like may be used. This applies to a value γ_{α,a,all} corresponding to the ath column vector selected multiple pieces or averaged with respect to η.

In addition, as in Formula (6), the amplitude information γ_{α,η} may be separated for each antenna, and each row vector g′_{α,1,η} to g′_{α,Mt,η} obtained by normalizing the norm value to a certain value and its amplitude value γ′_{α,1,η} to γ′_{α,Mt,η} may be obtained.

$$\begin{matrix}[ Formula 6 ] & \\ {H}_{α , η} = ( \begin{matrix}{γ}_{α , 1 , η}^{′} & 0 & 0 \\ 0 & ⋱ & 0 \\ 0 & 0 & {γ}_{α , Mt , η}^{′}\end{matrix} ) ( \begin{matrix}{g}_{α , 1 , η}^{′} \\ ⋮ \\ {g}_{α , Mt , η}^{′}\end{matrix} ) & ( 6 )\end{matrix}$$

For example, g′_{α,b,η} can be set as a specified vector such that ∥g′_{α,b,η}∥_{F}=1. A value obtained by converting γ′_{α,b,η} and γ′_{α,b,η}² into dB, defining the maximum value and the minimum value, and expressing the range with a value normalized within a range of 0 to 1 or the like may be used. This applies to a value γ′_{α,b,all} corresponding to the bth column vector selected multiple pieces or averaged with respect to η.

The channel matrix H_{α,η}, the normalized channel matrix G_{α,η}, the normalized vectors g_{α,a,η}, and the normalized vectors g′_{α,b,η} can use the real part and the imaginary part of each element as input features, can use the real part and the imaginary part as input information without change, can be converted into another format such as angle information, or can be quantized.

In addition, correlation matrices H_{α,η}H_{α,η}^{H} and H_{α,η}^{H}H_{α,η} generated using the channel matrix H_{α,η} can be used. Correlation matrices G_{α,η}G_{α,η}^{H} and G_{α,η}^{H}G_{α,η} generated using the channel matrix G_{α,η} can be used. A matrix ΣH_{α,η}, ΣG_{α,η}, ΣH_{α,η}H_{α,η}^{H}, ΣH_{α,η}^{H}H_{α,η}, ΣG_{a,η}G_{α,η}^{H}, or ΣG_{α,η}^{H}G_{α,η} obtained by summing or averaging the channel matrix H_{α,η}, the normalized channel matrix G_{α,η}, and the correlation matrices H_{α,η}H_{α,η}^{H}, H_{α,η}^{H}H_{α,η}, G_{α,η}G_{α,η}^{H}, and G_{α,η}^{H}G_{α,η} with respect to a plurality of frequencies can be used. An eigenvalue, a diagonal matrix, and a unitary matrix obtained by performing QR decomposition, SVD, eigenvector decomposition, or the like of these matrices can be used.

As an example, a case of using feedback of channel information used in IEEE 802.11n/ac/ax which is a wireless LAN standard will be described. This is to compress the right singular matrix obtained by the SVD of the channel matrices H_{α,η} in the above-described example into angle information, generate quantized data corresponding to a plurality of frequencies, and feed back the generated data. The unitary matrix is converted into the angles ϕ and ψ as the compressed beamforming feedback matrix, and is fed back together with the SNR information. While details are described in Non Patent Literature, as in Formula (7), a V matrix corresponding to a right singular matrix of a channel matrix can be obtained by performing a matrix operation using the angle information.

$$\begin{matrix}[ Formula 7 ] & \\ V = [ \begin{matrix}{e}^{j ϕ} \text{?} & 0 & … & 0 \\ 0 & ⋱ & ⋱ & ⋮ \\ ⋮ & ⋱ & {e}^{j ϕ} \text{?} & 0 \\ 0 & … & 0 & 1\end{matrix} ] \times [ \begin{matrix}cos {ψ}_{21} & - sin {ψ}_{21} & 0 & … & 0 \\ sin {ψ}_{21} & cos {ψ}_{21} & 0 & … & 0 \\ 0 & 0 & 1 & 0 & 0 \\ ⋮ & ⋮ & 0 & ⋱ & 0 \\ 0 & 0 & 0 & 0 & 1\end{matrix} ] \times … & ( 7 )\end{matrix}$$

$$… \times [ \begin{matrix}cos {ψ}_{( {M}_{t} - 1 ) 1} & 0 & … & - sin {ψ}_{( {M}_{t} - 1 ) 1} & 0 \\ 0 & 1 & 0 & 0 & ⋮ \\ ⋮ & 0 & ⋱ & 0 & 0 \\ sin {ψ}_{( {M}_{t} - 1 ) 1} & 0 & 0 & cos {ψ}_{( {M}_{t} - 1 ) 1} & 0 \\ 0 & 0 & … & 0 & 1\end{matrix} ] \times … \times [ \begin{matrix}{I}_{Ni} \\ 0\end{matrix} ] \\ \text{?} \text{indicates text missing or illegible when filed}$$

Ni is the number of reception antennas. Mt is the number of transmission antennas. This expression is expressed focusing on a certain frequency, and the V matrix of Formula (7) exists for the designated number of subcarriers, and angle information is generated for each subcarrier. Further, from the information corresponding to the eigenvalue of the channel matrix, together with the SNR information of the smaller number of antennas of either Ni or Mt, it is quantized with a designated quantization bit number, stored in a wireless signal, and transmitted. The wireless communication unit 1-r of the management device 1 can obtain the angle information and the SNR information, and further can obtain the RSSI information of the wireless signal.

The angle information may be used as it is as the input feature. The sine and cosine components calculated from the angle information may be used as the input feature. A matrix in which the angle information is returned to the right singular matrix may be used, using Formula (7). After the angle information is returned to the right singular matrix, an averaging matrix obtained by averaging the right singular matrix or the correlation matrix thereof in the frequency direction may be used. A matrix obtained by further performing signal processing such as QR decomposition on the averaging matrix may be used.

In the above-described format, since the imaginary part of the last element of each column vector of the right singular matrix compressed as the angle information is always 0, if the right singular matrix is obtained as a matrix of M×Ni, a numerical value of 2×Mt×Ni−Ni is meaningful information from the numerical values of the real part and the imaginary part of each element. For example, in a case where the right singular matrix is a 4×1 matrix, a total of seven elements of the real part 4 and the imaginary part 3 are meaningful information, and in a case where a 4×2 matrix is obtained, a total of 14 elements of the real part 8 and the imaginary part 6 are meaningful information. Since the imaginary part of the last element of each column is 0, the last element of each column may not be used.

### Experimental Results

The position estimation method of the present embodiment and the effect thereof will be described with reference to a specific example and an indoor experiment result.

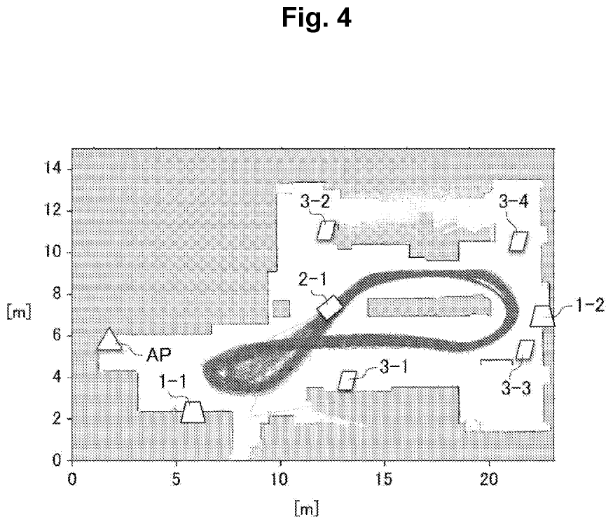

In the indoor experimental environment area illustrated in FIG. 4, four fixed terminals 3-1 to 3-4, one position estimation target 2-1, and a management device 1 to which two wireless communication units 1-1 and 1-2 are connected are arranged. The position estimation target 2-1 is traveling in a FIG. 8 in the center part in the experimental environment area. The fixed terminals 3-1 to 3-4 perform wireless communication with the base station AP as an access point.

The fixed terminals 3-1 to 3-4 and the position estimation target 2-1 are requested to report channel information every 100 ms from the base station AP, and perform feedback transmission of the angle information of the channel information using the channel information feedback method defined in the wireless LAN standard IEEE 802.11ac. The number of antennas of the base station AP is four. The number of antennas of the fixed terminals 3-1 to 3-4, the position estimation target 2-1, and the wireless communication units 1-1 and 1-2 is two. Communication at a carrier frequency of 5.66 GHz was performed using a bandwidth of 20 MHz.

The two wireless communication units 1-1 and 1-2 can obtain the angle information and the SNR generated from the right singular matrix of the channel matrix between the fixed terminals 3-1 to 3-4 and the base station AP, and the values of the RSSI of the wireless signals from the fixed terminals 3-1 to 3-4 in the wireless communication units 1-1 and 1-2. One RSSI was acquired from each of the wireless communication units 1-1 and 1-2.

The input feature generation unit 1-2 calculates a unitary matrix from the angle information according to the above-described formula, and averages the calculated unitary matrix by frequency. As a result, a total of 14 components of the real part 8 and the imaginary part 6 are obtained. In addition, input features of 14+2+2=18, which are obtained by normalizing the dB values of the two pieces of SNR information so as to be distributed in the range of 0 to 1 and by normalizing the dB values of the RSSI in the reception antennas of the wireless communication units 1-1 and 1-2 so as to be distributed in the range of 0 to 1, are acquired in a 100 ms cycle for each fixed terminal.

The position estimation method of the present embodiment and the effect thereof will be described with reference to a specific example and an indoor experiment result.

In the indoor experimental environment area illustrated in FIG. 4, four fixed terminals 3-1 to 3-4, one position estimation target 2-1 and 4-1, and a management device 1 to which two wireless communication units 1-1 and 1-2 are connected are arranged. The position estimation targets 2-1 and 4-1 are traveling in a FIG. 8 in the center part in the experimental environment area. The fixed terminals 3-1 to 3-4 perform wireless communication with the base station (Access Point (AP)) as an access point.

In order to generate the position estimation model according to the present embodiment, the autonomous running robot as the position estimation target 2-1 was made to run for 8 hours in the indoor experimental environment area. The travel data was set such that a line remaining in a FIG. 8 in FIG. 4 was an actual route of the robot, and the robot traveled while passing through the goal randomly set in a section of 60 cm so as not to pass through the exactly same route. At this time, the position estimation model training unit 1-4 generates training data in which highly accurate position information of the autonomous running robot obtained from light detection and ranging (LIDAR) included in the position estimation target and the control information of the tire and the input feature related to the propagation described above are arranged in the same time series in a 200 ms cycle. As described above, although the generation cycle of the input feature is 100 ms, the training data is generated by selecting and using the latest information obtained with the time width divided by the 200 ms cycle.

Then, using the generated training data, a position estimation model by a deep neural network using a gated recurrent unit (GRU) and direct coupling was trained. The learning rate was 0.0002, and ADAM was used as an optimization algorithm. The GRU was set to hidden layer 1 and dimension 35, and weight and bias were updated by back propagation so as to output X-coordinate and Y-coordinate information in the experimental environment area by using two directly connected layers of input 35 and output 35, and one directly connected layer of input 35 and output 2. The updated position estimation model was used.

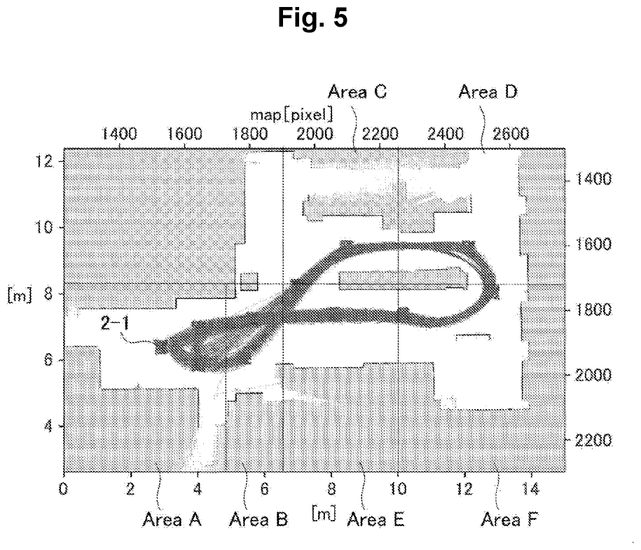

The position estimation model utilization unit 1-3 estimates the position of the position estimation target 2-1 using the fixed terminals 3-1 to 3-4 and the position estimation target 2-1. In addition, the experimental environment area was divided into six areas, Area A to Area F, as shown in FIG. 5, and evaluated.

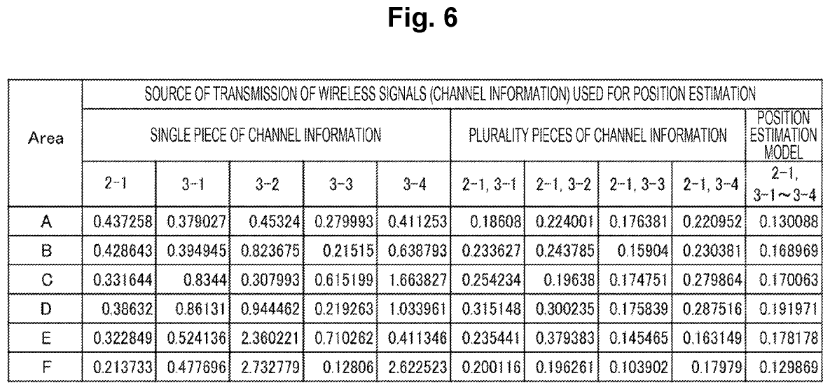

FIG. 6 illustrates a result of arranging the output subjected to the position estimation with the unit of error from the actual value as m. Here, the rightmost column is the output result of the position information by the position estimation model utilization unit, and the other columns correspond to the output of the position information by the individual management model. In the columns described as 2-1 and 3-1 to 3-4 on the rightmost side, the input features are generated using the channel information from all the wireless communication units, and it can be seen that high estimation accuracy of 20 cm or less is obtained in any place.

In addition, the individual management models corresponding to the wireless communication units of 2-1, 3-1, 3-2, 3-3, 3-4, {2-1, 3-1}, {2-1, 3-2}, {2-1, 3-3}, and {2-1, 3-4} are generated. First, it can be seen that the position estimation error of the individual management model corresponding to a single wireless communication unit has a very wide distribution from 20 cm to 2.7 m. In a case where an abnormality is detected using a single wireless communication unit as an individual management model, it is necessary to note that the position estimation accuracy itself may be poor. For example, when the fixed terminal 3-2 is used and the position estimation target is in Area E or F, the average position prediction error exceeds 2 m. In a case where the output is compared with the position information (teacher data) measured by another method or the output of the position prediction model utilization unit, a large error is detected, but in practice, the wireless communication unit of the fixed terminal 3-2 is not broken. That is, it is preferable to determine the abnormality in Area A or C, in which a condition under the prediction performance of the position estimation target is high. Even in the case of performing comparison based on simple position information, it is necessary to perform abnormality detection determination under a specific position condition.

Furthermore, from the position prediction performance of the individual management model in which a plurality of wireless communication units are combined, it can be seen that the position prediction result is very high and can be detected with an accuracy of 30 cm or less. As described above, the accuracy of the abnormality detection algorithm can be enhanced by enhancing the output system. If {2-1, 3-1}, {2-1, 3-2}, {2-1, 3-3}, and {2-1, 3-4} are set as the individual management model and any one of the outputs is abnormal, the corresponding fixed terminal 3-i can be specified as the cause of the abnormality. The result here is a result of using both reception signals of the wireless communication units 1-1 and 1-2, but by separating the wireless communication units 1-1 and 1-2 to be used, it is also possible to detect that there is a problem in the wireless communication unit of any of the management devices 1.

### Effects of Present Embodiment

According to the present embodiment, a management device 1 that performs wireless communication with a fixed terminal fixed in an environment, or performs wireless communication with the fixed terminal and a position estimation target, and manages a state of a wireless communication unit that performs wireless communication, in which at least one of the number of wireless communication units of the fixed terminal or the position estimation target and the wireless communication units of an own device being plural, includes one or more wireless communication units 1-1 to 1-R that receive a wireless signal from a wireless communication unit performing wireless communication included in the fixed terminal or a wireless communication unit included in the fixed terminal and the position estimation target and acquire a plurality of pieces of channel information related to radio wave propagation from the wireless signal, an input feature generation unit 1-2 that converts channel information corresponding to the plurality of wireless communication units into a plurality of input features that can be input to a machine learning model, a position estimation model utilization unit 1-3 that estimates and calculates a position of the position estimation target by inputting the plurality of input features to a position estimation model obtained by modeling, by machine learning, a relationship between position information of the position estimation target and an input feature, and a model evaluation unit 1-0-2 that outputs identification of whether or not an abnormality has occurred in any one of the wireless communication units of the fixed terminal or the position estimation target, and the own device, or an index for the identification by inputting each input feature of the input features of the plurality of wireless communication units to a generated individual management model for each of the fixed terminal or each of the position estimation target, for each wireless communication unit of the own device, or for a plurality of wireless communication units selected from the wireless communication units of the fixed terminal, the position estimation target, or the own device. That is, whether the individual wireless communication terminal or the individual wireless communication unit is normal is identified based on the individual management model that generates an input feature of the channel information in advance for each individual wireless communication terminal (fixed terminal and position estimation device), for each individual wireless communication unit that has received the wireless signal, for each plurality of wireless communication units selected from the wireless communication units of the wireless communication terminal, the position estimation target, and the management device, therefore, the technology that can individually manage the state of the wireless communication terminal or the wireless communication unit of the own device can be provided.

### Others

The present invention is not limited to the embodiment stated above. The present invention can be modified in various manners without departing from the gist of the present invention.

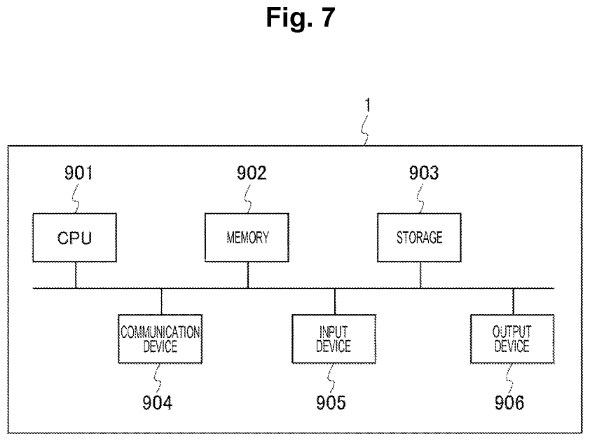

The management device 1 of the present embodiment described above can be implemented using, for example, a general-purpose computer system including a CPU 901, a memory 902, a storage 903, a communication device 904, an input device 905, and an output device 906 as illustrated in FIG. 7. The memory 902 and the storage 903 are storage devices. In the computer system, each function of the management device 1 is implemented by the CPU 901 executing a predetermined program loaded on the memory 902.

The management device 1 may be implemented by a single computer. The management device 1 may be implemented by a plurality of computers. The management device 1 may be a virtual machine that is implemented in a computer. The program for the management device 1 can be stored in a computer-readable recording medium such as HDDs, SSDs, USB memories, CDs, or DVDs. The program for the management device 1 can also be distributed via a communication network.

### REFERENCE SIGNS LIST

1 Management device
1-0 Position estimation model management unit
1-0-1-1 to 1-0-1-P Individual management model
1-0-2 Model evaluation unit
1-1 to 1-R Wireless communication unit
1-2 Input feature generation unit
1-3 Position estimation model utilization unit
1-4 Position estimation model training unit
2-1 to 2-Q Position estimation target
2-1-1 to 2-Q-1 Wireless communication unit
3-1 to 3-M Fixed terminal
3-1-1 to 3-M-1 Wireless communication unit
901 CPU
902 Memory
903 Storage
904 Communication device
905 Input device
906 Output device

1. A management device for performing wireless communication with a fixed terminal fixed in an environment, or performing wireless communication with the fixed terminal and a position estimation target, and managing a state of a wireless communication unit that performs wireless communication, at least one of the number of wireless communication units of the fixed terminal or the position estimation target and the wireless communication units of an own device being plural, the management device comprising:
one or more wireless communication units, each wireless communication unit including one or more processors, configured to receive a wireless signal from a wireless communication unit performing wireless communication included in the fixed terminal or a wireless communication unit included in the fixed terminal and the position estimation target and acquire a plurality of pieces of channel information related to radio wave propagation from the wireless signal;
an input feature generation unit, including one or more processors, configured to convert channel information corresponding to the plurality of wireless communication units into a plurality of input features that can be input to a machine learning model;
a position estimation model utilization unit, including one or more processors, configured to estimate and calculate a position of the position estimation target by inputting the plurality of input features to a position estimation model obtained by modeling, by machine learning, a relationship between position information of the position estimation target and an input feature; and
a model evaluation unit, including one or more processors, configured to output identification of whether or not an abnormality has occurred in any one of the wireless communication units of the fixed terminal or the position estimation target, and the own device, or an index for the identification by inputting each input feature of the input features of the plurality of wireless communication units to a generated individual management model for each of the fixed terminal or each of the position estimation target, for each wireless communication unit of the own device, or for a plurality of wireless communication units selected from the wireless communication units of the fixed terminal, the position estimation target, or the own device.

2. The management device according to claim 1, wherein
the individual management model is a position estimation model obtained by modeling, by machine learning, a relationship among channel information corresponding to a wireless communication unit of one fixed terminal, channel information corresponding to a wireless communication unit of one position estimation target, channel information corresponding to one wireless communication unit of the own device, or channel information corresponding to a plurality of wireless communication units selected from wireless communication units of a fixed terminal, a position estimation target, and the own device, and position information of the position estimation target, and the position estimation model outputs position information of the position estimation target based on one piece of channel information when an input feature of one piece of channel information is input, and
the model evaluation unit is configured to output an identification of a wireless communication unit in which an abnormality has occurred or an index for the identification by using a plurality of pieces of position information output from a plurality of the individual management models.

3. The management device according to claim 2, wherein
the model evaluation unit is configured to identify position information of a value to be an outlier in a set of the plurality of pieces of position information as being abnormal, or outputs an outlier degree of the outlier.

4. The management device according to claim 1, wherein
the individual management model is an abnormality detection algorithm that detects abnormality by learning, using machine learning, data at normal time, or data at normal time and abnormal time regarding channel information corresponding to a wireless communication unit of one fixed terminal, channel information corresponding to a wireless communication unit of one position estimation target, channel information corresponding to one wireless communication unit of the own device, or channel information corresponding to a plurality of wireless communication units selected from wireless communication units of a fixed terminal, a position estimation target, and the own device, and
the model evaluation unit is configured to output an abnormal identification or an index for an identification of a wireless communication unit of the fixed terminal or the position estimation target, or the own device, by using an abnormality detection result detected by the individual management model.

5. The management device according to claim 1, wherein
the model evaluation unit is configured to output an abnormal identification or an index for an identification of a wireless communication unit of the fixed terminal or the position estimation target, or the own device, by further using position information estimated and calculated by the position estimation model utilization unit, in addition to an abnormality detection result detected by the individual management model.

6. The management device according to claim 1, wherein
the input feature generation unit is configured to generate, as the input feature, one or more values of feature of a phase, an amplitude, a real component, an imaginary component, and a value obtained by normalizing a range of coefficient of the one or more values, among features related to reception power of the wireless signal, signal power, power ratio information obtained from a moving average of reception power or signal power, a channel matrix of the channel information, a correlation matrix of the channel matrix, an arithmetic matrix obtained by signal processing of the channel matrix, an arithmetic matrix obtained by signal processing of the correlation matrix, an arithmetic matrix obtained by signal processing of the channel matrix or the correlation matrix corresponding to a plurality of frequencies, a unitary matrix obtained by linear operation of the channel matrix, a unitary matrix obtained by linear operation of the correlation matrix, a unitary matrix obtained by linear operation of the arithmetic matrix, a diagonal matrix obtained by linear operation of the channel matrix, a diagonal matrix obtained by linear operation of the correlation matrix, a diagonal matrix obtained by linear operation of the arithmetic matrix, a triangular matrix obtained by linear operation of the channel matrix, a triangular matrix obtained by linear operation of the correlation matrix, and a triangular matrix obtained by linear operation of the arithmetic matrix.

7. A management method for performing wireless communication with a fixed terminal fixed in an environment, or performing wireless communication with the fixed terminal and a position estimation target, and managing a state of a wireless communication unit that performs wireless communication, at least one of the number of wireless communication units of the fixed terminal or the position estimation target and the wireless communication units of an own device being plural, the management method comprising steps of:
receiving, in the management device, by one or more wireless communication units, a wireless signal from a wireless communication unit performing wireless communication included in the fixed terminal or a wireless communication unit included in the fixed terminal and the position estimation target and acquiring a plurality of pieces of channel information related to radio wave propagation from the wireless signal;
converting, by an input feature generation unit, channel information corresponding to the plurality of wireless communication units into a plurality of input features that can be input to a machine learning model;
estimating and calculating, by a position estimation model utilization unit, a position of the position estimation target by inputting the plurality of input features to a position estimation model obtained by modeling, by machine learning, a relationship between position information of the position estimation target and an input feature; and
outputting, by a model evaluation unit, identification of whether or not an abnormality has occurred in any one of the wireless communication units of the fixed terminal or the position estimation target, and the own device, or an index for the identification by inputting each input feature of the input features of the plurality of wireless communication units to a generated individual management model for each of the fixed terminal or each of the position estimation target, for each wireless communication unit of the own device, or for a plurality of wireless communication units selected from the wireless communication units of the fixed terminal, the position estimation target, or the own device.

8. A non-transitory computer-readable storage medium storing a management program causing a computer to perform a management method for performing wireless communication with a fixed terminal fixed in an environment, or performing wireless communication with the fixed terminal and a position estimation target, and managing a state of a wireless communication unit that performs wireless communication, at least one of the number of wireless communication units of the fixed terminal or the position estimation target and the wireless communication units of an own device being plural, the management method comprising steps of:
receiving, in the management device, by one or more wireless communication units, a wireless signal from a wireless communication unit performing wireless communication included in the fixed terminal or a wireless communication unit included in the fixed terminal and the position estimation target and acquiring a plurality of pieces of channel information related to radio wave propagation from the wireless signal;
converting, by an input feature generation unit, channel information corresponding to the plurality of wireless communication units into a plurality of input features that can be input to a machine learning model;
estimating and calculating, by a position estimation model utilization unit, a position of the position estimation target by inputting the plurality of input features to a position estimation model obtained by modeling, by machine learning, a relationship between position information of the position estimation target and an input feature; and
outputting, by a model evaluation unit, identification of whether or not an abnormality has occurred in any one of the wireless communication units of the fixed terminal or the position estimation target, and the own device, or an index for the identification by inputting each input feature of the input features of the plurality of wireless communication units to a generated individual management model for each of the fixed terminal or each of the position estimation target, for each wireless communication unit of the own device, or for a plurality of wireless communication units selected from the wireless communication units of the fixed terminal, the position estimation target, or the own device.

9. The management method according to claim 7, wherein
the individual management model is a position estimation model obtained by modeling, by machine learning, a relationship among channel information corresponding to a wireless communication unit of one fixed terminal, channel information corresponding to a wireless communication unit of one position estimation target, channel information corresponding to one wireless communication unit of the own device, or channel information corresponding to a plurality of wireless communication units selected from wireless communication units of a fixed terminal, a position estimation target, and the own device, and position information of the position estimation target, and the position estimation model outputs position information of the position estimation target based on one piece of channel information when an input feature of one piece of channel information is input, and
the management method further comprises outputting an identification of a wireless communication unit in which an abnormality has occurred or an index for the identification by using a plurality of pieces of position information output from a plurality of the individual management models.

10. The management method according to claim 9, wherein
the management method further comprises identifying position information of a value to be an outlier in a set of the plurality of pieces of position information as being abnormal, or outputs an outlier degree of the outlier.

11. The management method according to claim 7, wherein
the individual management model is an abnormality detection algorithm that detects abnormality by learning, using machine learning, data at normal time, or data at normal time and abnormal time regarding channel information corresponding to a wireless communication unit of one fixed terminal, channel information corresponding to a wireless communication unit of one position estimation target, channel information corresponding to one wireless communication unit of the own device, or channel information corresponding to a plurality of wireless communication units selected from wireless communication units of a fixed terminal, a position estimation target, and the own device, and
the management method further comprises outputting an abnormal identification or an index for an identification of a wireless communication unit of the fixed terminal or the position estimation target, or the own device, by using an abnormality detection result detected by the individual management model.

12. The management method according to claim 7, wherein
the management method further comprises outputting an abnormal identification or an index for an identification of a wireless communication unit of the fixed terminal or the position estimation target, or the own device, by further using position information estimated and calculated by the position estimation model utilization unit, in addition to an abnormality detection result detected by the individual management model.

13. The management method according to claim 7, wherein
the management method further comprises generating, as the input feature, one or more values of feature of a phase, an amplitude, a real component, an imaginary component, and a value obtained by normalizing a range of coefficient of the one or more values, among features related to reception power of the wireless signal, signal power, power ratio information obtained from a moving average of reception power or signal power, a channel matrix of the channel information, a correlation matrix of the channel matrix, an arithmetic matrix obtained by signal processing of the channel matrix, an arithmetic matrix obtained by signal processing of the correlation matrix, an arithmetic matrix obtained by signal processing of the channel matrix or the correlation matrix corresponding to a plurality of frequencies, a unitary matrix obtained by linear operation of the channel matrix, a unitary matrix obtained by linear operation of the correlation matrix, a unitary matrix obtained by linear operation of the arithmetic matrix, a diagonal matrix obtained by linear operation of the channel matrix, a diagonal matrix obtained by linear operation of the correlation matrix, a diagonal matrix obtained by linear operation of the arithmetic matrix, a triangular matrix obtained by linear operation of the channel matrix, a triangular matrix obtained by linear operation of the correlation matrix, and a triangular matrix obtained by linear operation of the arithmetic matrix.

14. The non-transitory computer-readable storage medium according to claim 8, wherein
the individual management model is a position estimation model obtained by modeling, by machine learning, a relationship among channel information corresponding to a wireless communication unit of one fixed terminal, channel information corresponding to a wireless communication unit of one position estimation target, channel information corresponding to one wireless communication unit of the own device, or channel information corresponding to a plurality of wireless communication units selected from wireless communication units of a fixed terminal, a position estimation target, and the own device, and position information of the position estimation target, and the position estimation model outputs position information of the position estimation target based on one piece of channel information when an input feature of one piece of channel information is input, and
the management method further comprises outputting an identification of a wireless communication unit in which an abnormality has occurred or an index for the identification by using a plurality of pieces of position information output from a plurality of the individual management models.

15. non-transitory computer-readable storage medium according to claim 14, wherein
the management method further comprises identifying position information of a value to be an outlier in a set of the plurality of pieces of position information as being abnormal, or outputs an outlier degree of the outlier.

16. non-transitory computer-readable storage medium according to claim 8, wherein
the individual management model is an abnormality detection algorithm that detects abnormality by learning, using machine learning, data at normal time, or data at normal time and abnormal time regarding channel information corresponding to a wireless communication unit of one fixed terminal, channel information corresponding to a wireless communication unit of one position estimation target, channel information corresponding to one wireless communication unit of the own device, or channel information corresponding to a plurality of wireless communication units selected from wireless communication units of a fixed terminal, a position estimation target, and the own device, and
the management method further comprises outputting an abnormal identification or an index for an identification of a wireless communication unit of the fixed terminal or the position estimation target, or the own device, by using an abnormality detection result detected by the individual management model.

16. non-transitory computer-readable storage medium according to claim 8, wherein
the management method further comprises outputting an abnormal identification or an index for an identification of a wireless communication unit of the fixed terminal or the position estimation target, or the own device, by further using position information estimated and calculated by the position estimation model utilization unit, in addition to an abnormality detection result detected by the individual management model.

18. non-transitory computer-readable storage medium according to claim 8, wherein
the management method further comprises generating, as the input feature, one or more values of feature of a phase, an amplitude, a real component, an imaginary component, and a value obtained by normalizing a range of coefficient of the one or more values, among features related to reception power of the wireless signal, signal power, power ratio information obtained from a moving average of reception power or signal power, a channel matrix of the channel information, a correlation matrix of the channel matrix, an arithmetic matrix obtained by signal processing of the channel matrix, an arithmetic matrix obtained by signal processing of the correlation matrix, an arithmetic matrix obtained by signal processing of the channel matrix or the correlation matrix corresponding to a plurality of frequencies, a unitary matrix obtained by linear operation of the channel matrix, a unitary matrix obtained by linear operation of the correlation matrix, a unitary matrix obtained by linear operation of the arithmetic matrix, a diagonal matrix obtained by linear operation of the channel matrix, a diagonal matrix obtained by linear operation of the correlation matrix, a diagonal matrix obtained by linear operation of the arithmetic matrix, a triangular matrix obtained by linear operation of the channel matrix, a triangular matrix obtained by linear operation of the correlation matrix, and a triangular matrix obtained by linear operation of the arithmetic matrix.
